(19) United States
(12) Patent Application Publication
(10) Pub. No.: US 2024/0362483 A1
(43) Pub. Date: Oct. 31, 2024

(54) INFORMATION PROCESSING APPARATUS, INFORMATION PROCESSING METHOD AND PROGRAM

(71) Applicant: Nippon Telegraph and Telephone Corporation, Tokyo (JP)

(72) Inventors: Jingyu SUN, Musashino-shi, Tokyo (JP); Susumu TAKEUCHI, Musashino-shi, Tokyo (JP); Yukiko YOSUKE, Musashino-shi, Tokyo (JP); Hongjie ZHAI, Musashino-shi, Tokyo (JP); Kazuyuki TAKAYA, Musashino-shi, Tokyo (JP); Ikuo YAMASAKI, Musashino-shi, Tokyo (JP)

(21) Appl. No.: 18/686,916

(22) PCT Filed: Sep. 6, 2021
(86) PCT No.: PCT/JP2021/032649

§ 371 Date: Feb. 27, 2024

(51) Int. Cl. G06N 3/08

(52) U.S. Cl. CPC G06N 3/08

(57) ABSTRACT

An information processing device includes: an input unit that inputs a plurality of pieces of time-series data measured by a respective plurality of sensors at different positions; and a processing unit that divides the plurality of pieces of the time-series data into a plurality of pieces of partial time-series data at predetermined time intervals, generates a plurality of primary capsules each including a feature vector of each of the plurality of pieces of the partial time-series data regarding the plurality of pieces of the time-series data, performs graph modeling to generate a weighting matrix in which a connection relationship between the plurality of primary capsules is indicated by a weight corresponding to a distance between the plurality of sensors and the predetermined time interval, and performs graph Fourier transform on the feature vector of each of the plurality of primary capsules based on the weighting matrix.

### TECHNICAL FIELD

The present invention relates to an information processing device, an information processing method, and an information processing program.

### BACKGROUND ART

Enormous data can be collected from a plurality of types of sensors by using IoT and AI. For example, it is possible to collect a large number of various types of data such as image data of a road measured by an in-vehicle camera, position data of a vehicle measured by a GPS, soil data of a paddy field measured by a drone, and growth data of rice plants measured by a sensor.

Meanwhile, a relationship between data is complicated and difficult. With the progress of a smart city, autonomous driving technology, and the like, it is necessary to simultaneously analyze various types of data by the same analysis method and perform countermeasures against the analysis results. Therefore, a technique of performing cooperative learning and inference in consideration of the relationship between data is becoming important.

One type of conventional machine learning for performing data analysis is deep learning in which layers of neurons are deeply multilayered. An example thereof is a convolutional neural network (CNN). The CNN is a deep learning model having convolutional layers that extract features of an image, pooling layers that reduce dimensions of the extracted features, and connected layers that classify the image. Learning is to adjust a degree of connection (weight) between neurons such that a value of an output result matches with an input image, and inference is to determine the input image by using the CNN subjected to the weight adjustment.

However, in the CNN, a neuron itself serving as a learning unit lacks the ability to accurately express a feature element in data. In particular, because the pooling layers are used, a spatial positional relationship between a plurality of feature elements is lost. Thus, a relationship between features in data and inference results is unclear. That is, interpretability of learning for data is insufficient in the CNN, which is difficult for humans to understand. Therefore, it is difficult to achieve human-in-the-loop (HITL) in which humans are partially involved in determination.

In view of this, Non Patent Literature 1 discloses a capsule network as a model capable of recognizing and recording feature elements in data. The feature elements in the data are input and output by scalars in the CNN, but, in the capsule network, the feature elements are input and output by vectors. Each axis of the vector stores the feature element in the data. In the capsule network that executes a task of “recognizing the presence of a line”, for example, information regarding a thickness of a line is stored in the first axis, and an orientation of the line is stored in the second axis. The capsule refers to a state in which information of multidimensional feature elements in pixel units, object units, or the like is vectorized and held.

Unlike the CNN, in the capsule network, (1) a vector is used instead of a scalar, (2) processing of giving a spatial relationship to a feature element in data is added, (3) dynamic routing is used instead of backpropagation to weight an output vector, and (4) a squashing function is used instead of a sigmoid function as an activation function. Hereinafter, a processing procedure of the capsule network will be outlined.

Procedure 1. Image data is subjected to convolution processing to obtain a plurality of multidimensional vectors uᵢ (see FIG. 6 of Non Patent Literature 1 and “Algorithm 1: Capsule Networks” in Non Patent Literature 2). The multidimensional vectors uᵢ are referred to as primary capsules, and a layer thereof is referred to as a primary capsule layer. The vectors uᵢ of the primary capsules are, for example, vectors of capsules corresponding to a human hand.

Procedure 2. The vectors uᵢ of the primary capsules are multiplied by a weighting matrix Wᵢⱼ corresponding to the vectors uᵢ to obtain vectors u_{j|i} (hat symbol (\hat{ }) above u) (see Non Patent Literature 2). For example, a weight indicating a spatial relationship between a hand and a human body is given. Further, a vector of each capsule for a foot or the like is also subjected to Procedure 1 and Procedure 2.

Procedure 3. Each vector u_{j|i} is multiplied by each weight cᵢⱼ to obtain a sum, and the sum Σᵢcᵢⱼu_{j|i} is set as an input vector sⱼ for the next layer (see Non Patent Literature 2). The weight cᵢⱼ is calculated by a method called dynamic routing at the time of learning the capsule network.

Procedure 4. In the next layer, a squashing function is applied to the input vector sⱼ to obtain an output vector vⱼ (see Non Patent Literature 2). The output vector vⱼ is a vector of the capsule for the human body based on a spatial positional relationship between parts. The squashing function is an activation function that scales a length of the input vector sⱼ within a range of 0 to 1 while maintaining an orientation thereof. The output vector vⱼ is referred to as a digit capsule, and a layer thereof is referred to as a digit capsule layer.

Here, the weight cᵢⱼ is a degree of connection indicating how the vectors uᵢ are connected in the whole and is calculated from “cᵢⱼ= {exp (bᵢⱼ)}/{Σₖexp (bᵢₖ)}” by using a softmax function. A calculation method for optimizing a value of bᵢⱼ at the time of learning is dynamic routing, and a situation of connection between the vectors uᵢ in the whole can be dynamically changed. Dynamic routing is a method of calculating how important each capsule is when a high-level capsule in the next layer is generated from a lower-level capsule in a previous layer.

Here, the value of bᵢⱼ is updated by “bᵢⱼ←bᵢⱼ+u_{j|i}·Vⱼ”. The expression “u_{j|i}·Vⱼ” is referred to as agreement calculation to calculate a matching degree between a vector of a primary capsule in a previous layer and a vector of a digital capsule in the next layer.

However, the agreement calculation takes a lot of calculation resources and time, which is inefficient. In particular, the number of parameters of the weighting matrix Wᵢⱼ used for calculating u_{j|i} and vⱼ is enormous. The number of parameters is two to three times that of the CNN, and thus a time required for the value of bᵢⱼ to converge is ten to thirty times that of the CNN. As a result, the output vector vi is calculated while a plurality of feature elements in the data are being intertwined, and thus the feature elements may not be appropriately separated from each other.

Therefore, Non Patent Literature 2 discloses a graph capsule network. In the graph capsule network, the calculation method of dynamic routing having a large amount of calculation is replaced with a calculation method of multihead attention-based graph pooling (see FIG. 1 of Non Patent Literature 2).

Processing procedures of the graph capsule network are different from those of the capsule network in Procedure 2 and Procedure 3. The multidimensional vectors uᵢ obtained in Procedure 1 are transformed into respective nodes of a graph having K² nodes with identity. Then, the transformed vector uᵢ′ of each node is multiplied by a weighting matrix A indicating a weight (=attention) between adjacent nodes to obtain a graph corresponding to the vectors uᵢ. Thereafter, a capsule group of the feature vectors uᵢ′ included in the graph is dimensionally reduced to obtain an input vector sⱼ for the next layer.

### CITATION LIST

### Non Patent Literature

Non Patent Literature 1: Rinat Mukhometzianov, and one other, “CapsNet comparative performance evaluation for image classification”
Non Patent Literature 2: Jindong Gu, and one other, “Interpretable Graph Capsule Networks for Object Recognition”, arXiv: 2012. 01674v3 [cs.CV] 7 Mar. 2021

### SUMMARY OF INVENTION

### Technical Problem

However, Non Patent Literature 2 merely discloses a technique of encapsulating image data having feature elements in a space. Thus, it is difficult to apply the technique to time-series data having feature elements on a time axis. Further, Non Patent Literature 2 does not disclose a mechanism for separating feature elements of time-series data from each other. Thus, an output vector is calculated while the feature elements in the time-series data are being intertwined.

The present invention has been made in view of the above circumstances, and an object of the present invention is to provide a technique capable of improving classification accuracy of each feature element included in multidimensional time-series data having feature elements in a spacetime.

### Solution to Problem

An information processing device according to an aspect of the present invention includes: an input unit that inputs a plurality of pieces of time-series data measured by a respective plurality of sensors at different positions; and a processing unit that divides the plurality of pieces of the time-series data into a plurality of pieces of partial time-series data at predetermined time intervals, generates a plurality of primary capsules each including a feature vector of each of the plurality of pieces of the partial time-series data regarding the plurality of pieces of the time-series data, performs graph modeling to generate a weighting matrix in which a connection relationship between the plurality of primary capsules is indicated by a weight corresponding to a distance between the plurality of sensors and the predetermined time interval, and performs graph Fourier transform on the feature vector of each of the plurality of primary capsules based on the weighting matrix.

An information processing device according to an aspect of the present invention includes: an input unit that inputs a plurality of pieces of time-series data measured by a respective plurality of sensors at different positions; and a processing unit that uses the plurality of pieces of the time-series data to separately generate a plurality of primary capsules each including a feature vector of each piece of the time-series data and a plurality of primary capsules each including a feature vector at each predetermined time interval.

An information processing method according to an aspect of the present invention is an information processing method performed in an information processing device, the information processing method including: a step of inputting a plurality of pieces of time-series data measured by a respective plurality of sensors at different positions; and a step of dividing the plurality of pieces of the time-series data into a plurality of pieces of partial time-series data at predetermined time intervals, generating a plurality of primary capsules each including a feature vector of each of the plurality of pieces of the partial time-series data regarding the plurality of pieces of the time-series data, performing graph modeling to generate a weighting matrix in which a connection relationship between the plurality of primary capsules is indicated by a weight corresponding to a distance between the plurality of sensors and the predetermined time interval, and performing graph Fourier transform on the feature vector of each of the plurality of primary capsules based on the weighting matrix.

An information processing method according to an aspect of the present invention is an information processing method performed in an information processing device, the information processing method including: a step of inputting a plurality of pieces of time-series data measured by a respective plurality of sensors at different positions; and a step of using the plurality of pieces of the time-series data to separately generate a plurality of primary capsules each including a feature vector of each piece of the time-series data and a plurality of primary capsules each including a feature vector at each predetermined time interval.

An information processing program according to an aspect of the present invention causes a computer to function as the above information processing device.

### Advantageous Effects of Invention

The present invention can provide a technique capable of improving classification accuracy of each feature element included in multidimensional time-series data having feature elements in a spacetime.

### BRIEF DESCRIPTION OF DRAWINGS

FIG. 1 shows a functional block configuration of an information processing device.

FIG. 2 shows a processing flow of an information processing device according to a first embodiment.

FIG. 3 illustrates a processing image of the information processing device according to the first embodiment.

FIG. 4 illustrates an image of dividing a time-series data group.

FIG. 5 illustrates an image of encapsulation.

FIG. 6 illustrates an image of graph modeling.

FIG. 7 illustrates an image of graph Fourier transform.

FIG. 8 illustrates an image of filtering.

FIG. 9 illustrates an image of attention calculation.

FIG. 10 illustrates an image of classifying signal values.

FIG. 11 shows a processing flow of an information processing device according to a second embodiment.

FIG. 12 illustrates a processing image of the information processing device according to the second embodiment.

FIG. 13 shows a hardware configuration of an information processing device.

### DESCRIPTION OF EMBODIMENTS

Hereinafter, embodiments of the present invention will be described with reference to the drawings. In the drawings, the same parts are denoted by the same reference signs, and the description thereof is omitted.

### SUMMARY OF INVENTION

In order to solve the above problems, the present invention discloses two embodiments.

A first embodiment discloses a method of, regarding multidimensional time-series data having feature elements in a spacetime, generating a capsule by simultaneously graphically modeling the feature elements in the spacetime. In particular, graph modeling is performed by using a weighting matrix based on both a spatial axis and a time axis in order to apply the present invention not only to feature elements on the spatial axis but also to feature elements on the time axis. In order to improve classification accuracy of each feature element included in the time-series data, graph Fourier transform for transforming a feature element in a spatiotemporal domain into a spectral domain is performed. Therefore, the present invention can also be applied to multidimensional time-series data having feature elements on the time axis, and the feature elements can be completely separated from each other.

A second embodiment discloses a method of, regarding multidimensional time-series data having feature elements in a spacetime, separately encapsulating feature elements on a spatial axis and on a time axis. The feature elements are separated into the feature elements on the spatial axis and the feature elements on the time axis and are then encapsulated. Thus, the present invention can also be applied to multidimensional time-series data having feature elements on the time axis, and feature elements can be completely separated from each other.

### First Embodiment

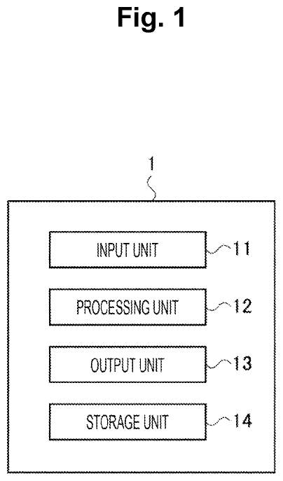

FIG. 1 shows a functional block configuration of an information processing device 1 according to the first embodiment. The information processing device 1 includes an input unit 11, a processing unit 12, an output unit 13, and a storage unit 14.

The input unit 11 has a function of inputting a plurality of pieces of time-series data measured by a respective plurality of sensors at different positions.

The processing unit 12 has a function of dividing the plurality of pieces of the time-series data into a plurality of pieces of partial time-series data at predetermined time intervals, generating a plurality of primary capsules each including a feature vector of each of the plurality of pieces of the partial time-series data regarding the plurality of pieces of the time-series data, performing graph modeling to generate a weighting matrix in which a connection relationship between the plurality of primary capsules is indicated by a weight corresponding to a distance between the plurality of sensors and the predetermined time interval, and performing graph Fourier transform on the feature vector of each of the plurality of primary capsules based on the weighting matrix.

The processing unit 12 has a function of generating a plurality of capsules in a spectral domain by classifying a plurality of signal values included in a respective plurality of bases obtained by the graph Fourier transform according to signal values at the same position in the bases and calculating attention of a classification class on the basis of a magnitude of the signal values included in the plurality of capsules.

The output unit 13 has a function of outputting an inference result of a task inferred on the basis of a calculation result of the attention of the classification class.

The storage unit 14 has a function of storing arbitrary data used for learning or inference. The storage unit 14 stores, for example, the plurality of pieces of the time-series data input to the information processing device 1, a learning model used for learning or inference, and various parameters of the learning model.

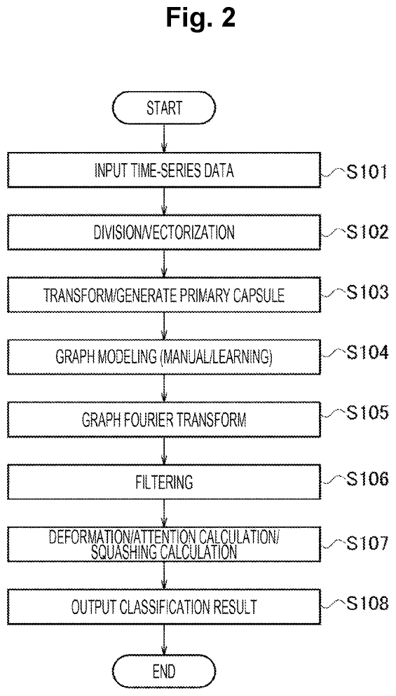

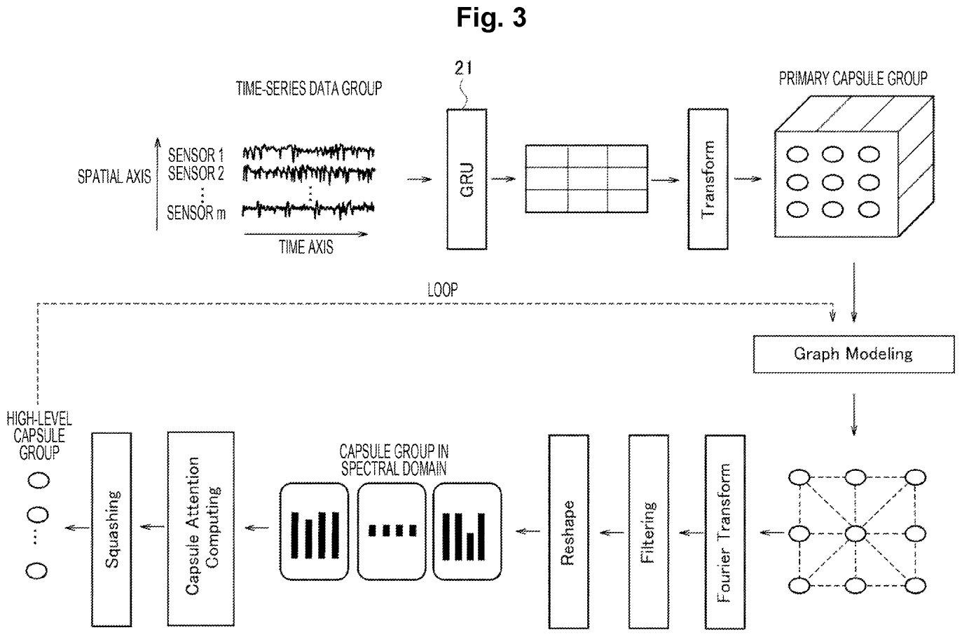

FIG. 2 shows a processing flow of the information processing device 1 according to the first embodiment. FIG. 3 illustrates a processing image of the information processing device 1 according to the first embodiment.

### Step S101;

The input unit 11 inputs a group X {x₁, x₂, . . . , xₘ} (xᵢ ∈R¹) of m pieces of time-series data. Here, m denotes the total number of pieces of time-series data. R denotes a real number space. 1 denotes a time length of time-series data xᵢ. 1 also denotes the total number of timestamps (measurement times). The time-series data is, for example, time-series data of electrocardiographic values measured by a sensor 1, time-series data of electroencephalogram values measured by a sensor 2, . . . , and time-series data measured by a sensor m. The time-series data used in the first embodiment is preferably data sensitive to a spectral space.

### Step S102;

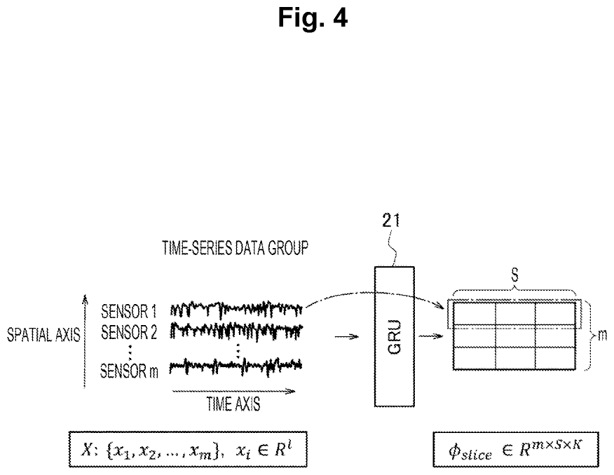

Next, the processing unit 12 inputs the group X of m pieces of the time-series data to a gated recurrent unit (GRU) 21 (see FIG. 4). The GRU 21 outputs, to a K-axis called a hidden state or a hidden layer, a feature vector of each piece of partial time-series data xᵢ′ obtained by dividing the time length 1 of the time-series data xᵢ by a predetermined partition number S. That is, when the group X of m pieces of the time-series data is input, the GRU 21 outputs a group of (m×S) feature vectors ϕ_{slice}∈R^{m×S×k} to the K-axis. The total number of feature vectors to be output to the K-axis can be set in the GRU 21 in advance. In a case where the total number of feature vectors is set to a plurality of vectors, a plurality of feature vectors is output to each of the (m×S) K-axes.

### Step S103;

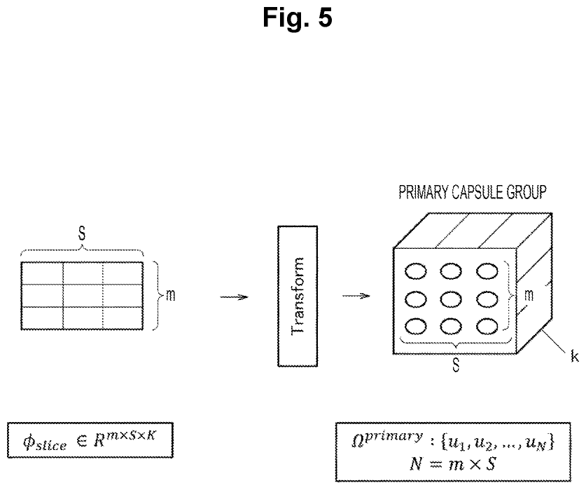

Next, the processing unit 12 changes the axis order of the feature vector group ϕ_{slice} ∈R^{m×s×k} from “m-axis, S-axis, K-axis” to “K-axis, m-axis, S-axis” and encapsulates a feature vector u_{N} (N=m× S) of each K-axis (see FIG. 5). This capsule is called a primary capsule. Therefore, a primary capsule group Ω^{primary}{u₁, u₂, . . . , u_{N}} having a plurality of primary capsules of the feature vectors u_{N} is obtained. Note that the change of the axis order is preprocessing for performing multiplication of matrices by graph Fourier transform in step S105.

### Step S104;

Next, the processing unit 12 performs graph modeling. Graph modeling is processing of determining a weight between primary capsules. That is, graph modeling is processing of generating a weighting matrix to be applied to the primary capsule group Ω^{primary}{u₁, u₂, . . . , u_{N}}.

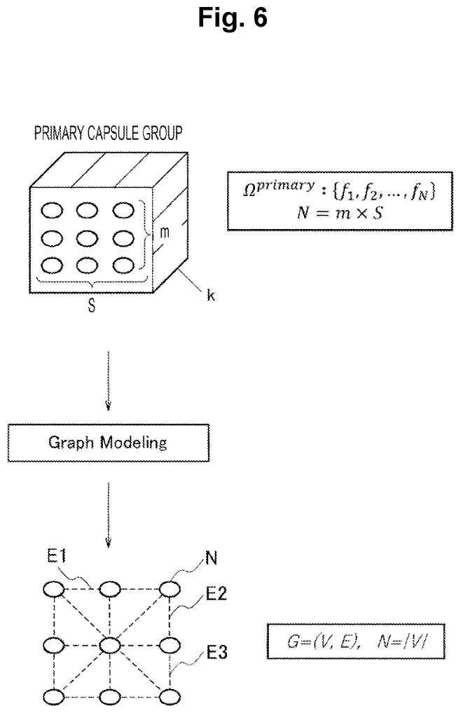

In graph modeling, modeling into a graph G (V, E) is performed by setting a primary capsule as a node N(=|V|) and the degree of connection (weight) between adjacent primary capsules as an edge E. As illustrated in FIG. 6, a horizontal edge E₁ indicates a temporal relationship between primary capsules generated on the basis of time-series data of one sensor. A vertical edge E₂ indicates a spatial relationship between primary capsules at the same time generated on the basis of time-series data of different sensors. An oblique edge E₃ indicates both the spatial relationship and the temporal relationship.

As a method of generating a weighting matrix, there are a method of manually setting a weight (attention) between nodes and a method of determining the weight by machine learning. In a case where the weight is manually set, the weighting matrix A_{i,j} ∈R^{N×N} is calculated by Equation (1).

$$\begin{matrix}[ Math . 1 ] & \\ {A}_{i , j} = {e}^{( - \frac{τ {‖ {t}_{i} - {t}_{j} ‖}^{2} + ( 1 - τ ) {‖ {s}_{i} - {s}_{j} ‖}^{2}}{2 {σ}^{2}} )} & ( 1 )\end{matrix}$$

The expression “tᵢ-tⱼ” denotes a difference between adjacent timestamps in a time-axis direction between the nodes. The expression “Sᵢ-Sⱼ” is a spatial distance between sensors in a spatial-axis direction between the nodes. In a case where the weight is manually set, a human sets in advance the difference between the adjacent timestamps and the spatial distance between the sensors. Regarding this point, Non Patent Literature 2 discloses that a weighting matrix is generated only on the basis of the spatial axis, as can be seen from Equation (1) of Non Patent Literature 2. Meanwhile, in the present embodiment, the weighting matrix based on both the spatial axis and the time axis is generated as in Equation (1) described above. Thus, the present invention can also be applied to time-series data having feature elements on the time axis.

Meanwhile, in a case where the weight is determined by machine learning, the weight of the weighting matrix is subjected to machine learning. The weight of each edge is arbitrarily set in advance, and the weight is automatically updated in the process of machine learning. As shown in Equation (2), the processing unit 12 prepares two learnable matrices W_{key} and W_{query}, multiplies each of the two matrices by the primary capsule group Ω^{primary}, and then applies the softmax function to calculate the weighting matrix A_{i,j}.

$$\begin{matrix}[ Math . 2 ] & \\ {A}_{i , j} = softmax ( {Ω}^{primary} \times {W}_{key} \times {( {Ω}^{primary} \times {W}_{query} )}^{T} ) & ( 2 )\end{matrix}$$

The above is the method of generating the weighting matrix A_{i,j}. At this timing, the processing unit 12 calculates a diagonal matrix D_{i,j} ∈R^{N×N} of the weighting matrix A_{i,j} by calculating the sum of each column as shown in Equation (3).

$$\begin{matrix}[ Math . 3 ] & \\ {D}_{i , j} = 0 , if i \neq j , else {D}_{i , j} = d ( i ) , d ( i ) = {\sum }_{j} {A}_{i , j} & ( 3 )\end{matrix}$$

The processing unit 12 replaces the feature vectors {u₁, u₂, . . . , u_{N}} of the N primary capsules with signal values F {f₁, f₂, . . . , f_{N}} of N nodes. This replacement is processing for handling the feature vectors of the primary capsules as the signal values of the nodes. A signal value fᵢ has the same value as the feature vector uᵢ on the K-axis.

### Step S105;

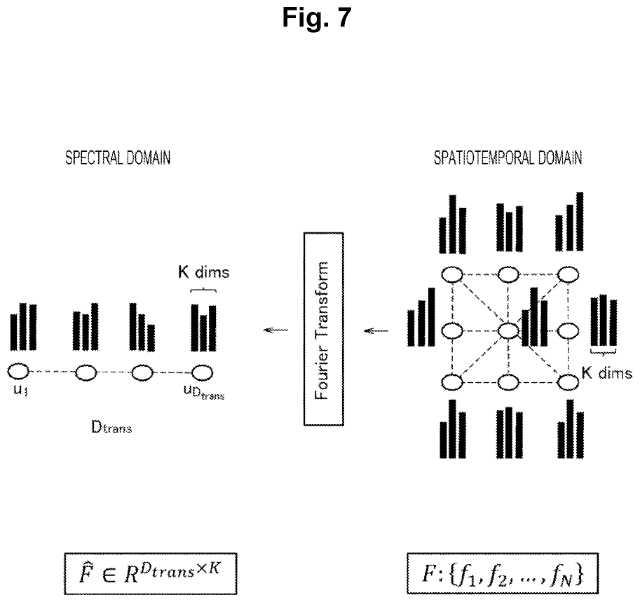

Next, the processing unit 12 performs graph Fourier transform on a spatiotemporal domain of the graph model into a spectral domain. FIG. 7 illustrates a case where there are three signal values (the total number of feature vectors on the K-axis is three) in each of the N nodes. The length of the signal value indicates a magnitude of a scalar of the feature vector. Hereinafter, a method of the graph Fourier transform will be described.

First, the processing unit 12 calculates graph Laplacian L ∈R^{N×N} by subtracting the weighting matrix A_{i,j} from the diagonal matrix D_{i,j} as shown in Equation (4).

$$\begin{matrix}[ Math . 4 ] & \\ L = D - A , L ∈ {R}^{N \times N} & ( 4 )\end{matrix}$$

Next, the processing unit 12 spectrally decomposes the graph Laplacian L to calculate a transposed matrix UT of a unitary matrix U ∈R^{N×Dtrans} as shown by Equation (5).

$$\begin{matrix}[ Math . 5 ] & \\ L = U ⋀ {U}^{T} , U ∈ {R}^{N \times {D}_{trans}} & ( 5 )\end{matrix}$$

Thereafter, as shown in Equation (6), the processing unit 12 multiplies the signal values F of the N nodes by the transposed matrix UT of the unitary matrix U to calculate signal values F ∈R^{Dtrans×K} (hat symbol (\hat{ }) above F) in the spectral domain. Hereinafter, the hat symbol will be simply referred to as “(\hat{ })”.

$$\begin{matrix}[ Math . 6 ] & \\ \hat{F} = {U}^{T} F , \hat{F} ∈ {R}^{{D}_{trans} \times K} & ( 6 )\end{matrix}$$

The signal values F (\hat{ }) subjected to the graph Fourier transform are a matrix in the form of “D bases u₁ to U_{Dtrans}×K”. That is, K feature vectors (hereinafter, also referred to as “dimensions” in order to facilitate understanding) are output for each base u. The total number K is the same as the total number of signal values of each node before the transform (the total number of feature vectors on the K-axis). Note that there is no positional correspondence between the signal values before and after the graph Fourier transform.

As described above, in the present embodiment, the signal value F of each node in the spatiotemporal domain is subjected to the graph Fourier transform into the signal value F (\hat{ }) in the spectral domain. Thus, feature elements of the signal values between the plurality of nodes can be reliably separated by the principle of the graph Fourier transform.

That is, in steps S104 and S105, graph modeling is performed to once give the connection relationship of the weight between the nodes. However, the feature element of each node is supposed to be different for each node, and thus an influence between the nodes is eliminated by performing graph Fourier transform, that is, by transforming a spacetime into a spectral space to transform the axis not into the spatial axis or the time axis, but into a frequency axis.

### Step S106;

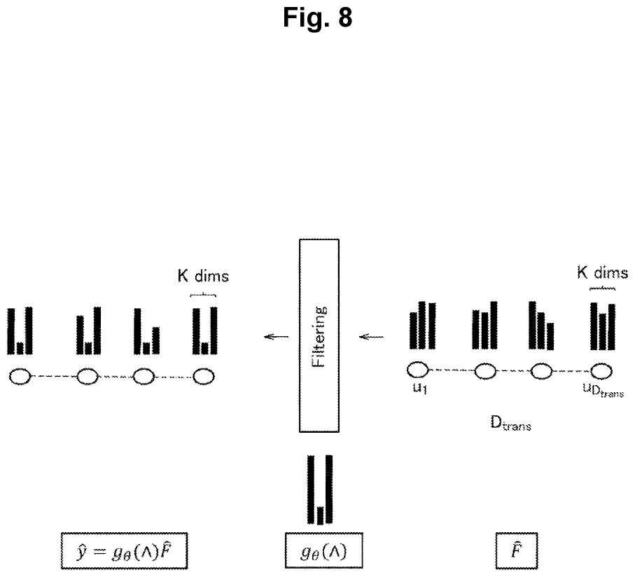

Next, the processing unit 12 performs filtering processing in order to extract only a target signal value from the K signal values F (\hat{ }) included in each base u in the spectral domain (see FIG. 8). Specifically, as shown in Equation (7), a signal value y (\hat{ }) ∈R^{Dtrans×K} subjected to the filtering processing is calculated by multiplying the signal values F (\hat{ }) in the spectral domain by a predetermined filtering function gₑ (∧).

$$\begin{matrix}[ Math . 7 ] & \\ \hat{y} = {g}_{θ} ( ⋀ ) \hat{F} & ( 7 )\end{matrix}$$

In step S106, in some cases, it is unknown which dimension is effective for a final classification task among K dimensions included in each base u in the spectral domain. Therefore, an unimportant noise signal is eliminated by performing the filtering processing such that only a target dimension remains.

### Step S107;

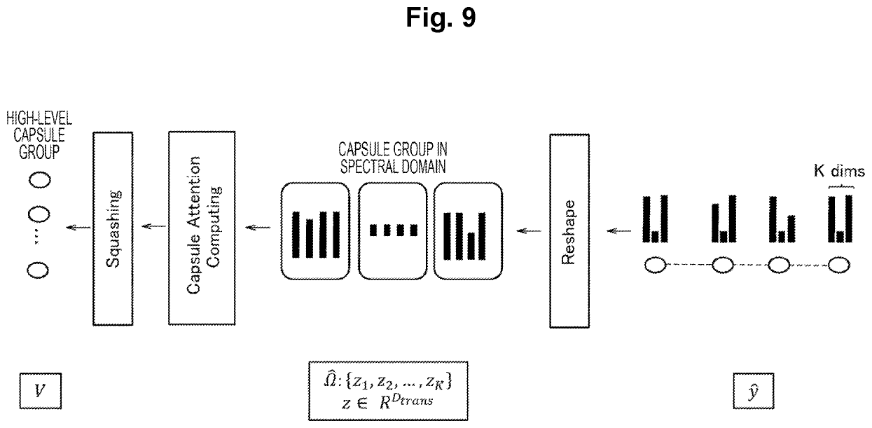

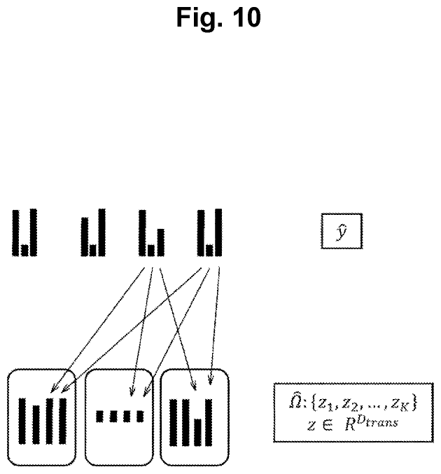

Next, the processing unit 12 transforms the signal value y (\hat{ }) ∈R^{Dtrans×K} subjected to the filtering processing into a signal value y (\hat{ }) ∈R^{K×Dtrans} as preprocessing for performing graph attention calculation described later (see FIG. 9). Specifically, as illustrated in FIG. 10, “D bases u×K dimensions” is transformed into “K×D dimensions” by classifying the K dimensions included in each base u according to the dimension at the same position. A unit of this classification is a capsule group Ω(\hat{ }) {z₁, z₂, . . . , z_{K}}, Z ∈R^{Dtrans}, and Ω(\hat{ }) ∈R^{K×Dtrans} in the spectral domain.

A plurality of dimensions included in each capsule are completely separated from each other by the graph Fourier transform already performed. It is possible to determine an important capsule on the basis of the magnitude of the scalar of the dimension included in the capsule, and the capsule serves as a determination source of attention of the graph.

Next, the processing unit 12 calculates the attention of the graph. Specifically, as shown in Equation (8), a graph attention Att is calculated by multiplying the capsule group Ω(\hat{ }) in the spectral domain by a learnable parameter W. The parameter W is a parameter in the form of R^{Dtrans×M}. M denotes the total number of classification tasks.

$$\begin{matrix}[ Math . 8 ] & \\ Att = \hat{Ω} W , Att ∈ {R}^{K \times M} & ( 8 )\end{matrix}$$

Thereafter, the processing unit 12 calculates an output vector v on the basis of the graph attention Att. Specifically, first, as shown in Equation (9), the capsule group Ω(\hat{ }) is multiplied by a transposed matrix Att™ of the graph attention Att to calculate a classification result S{s₁, s₂, . . . , sₘ} (s₁ ∈R^{Dtrans}) in the form of R^{Dtrans×M}. The classification result S is a matrix in the form of “M×Dₜᵣₐₙₛ”.

$$\begin{matrix}[ Math . 9 ] & \\ S = {Att}^{T} \hat{Ω} of shape {R}^{M \times {D}_{trans}} & ( 9 )\end{matrix}$$

Thereafter, the output vector v is calculated by applying the squashing function in Equation (10) to each classification result Sᵢ. A capsule of the output vector is called a high-level capsule.

$$\begin{matrix}[ Math . 10 ] & \\ squashing ( s ) = \frac{{‖ s ‖}^{2}}{1 + {‖ s ‖}^{2}} \frac{s}{‖ s ‖} & ( 10 )\end{matrix}$$

### Step S108;

Finally, the output unit 13 outputs the output vector v of the high-level capsule.

Summarizing the above, in the first embodiment, the GRU processing, the division processing, and the transform processing are applied to composite time-series data obtained from the plurality of sensors to generate primary capsules, which makes it possible to store a plurality of feature elements for each dimension and to implement a learning model capable of disentangling feature elements in the time-series data.

Further, in the first embodiment, the feature elements in the time-series data are separated from each other by simultaneously graphically modeling a relationship with a spacetime for the time-series data sensitive to the spectral space, applying the graph Fourier transform, and calculating attention of the graph in the spectral domain. This makes it possible to implement a learning process capable of effectively disentangling the feature elements.

According to the first embodiment, the information processing device 1 includes: the input unit 11 that inputs a plurality of pieces of time-series data measured by a respective plurality of sensors at different positions; and the processing unit 12 that divides the plurality of pieces of the time-series data into a plurality of pieces of partial time-series data at predetermined time intervals, generates a plurality of primary capsules each including a feature vector of each of the plurality of pieces of the partial time-series data regarding the plurality of pieces of the time-series data, performs graph modeling to generate a weighting matrix in which a connection relationship between the plurality of primary capsules is indicated by a weight corresponding to a distance between the plurality of sensors and the predetermined time interval, and performs graph Fourier transform on the feature vector of each of the plurality of primary capsules based on the weighting matrix. Thus, it is possible to apply the present invention also to multidimensional time-series data having feature elements on the time axis and also to completely separate the feature elements from each other. As a result, it is possible to provide a technique capable of improving classification accuracy of each feature element included in multidimensional time-series data having feature elements in a spacetime.

In the first embodiment, the GRU processing, the division processing, and the transform processing are performed on time-series data to generate primary capsules. However, this is merely an example of a method of generating primary capsules. Other types of processing may be performed as long as spatiotemporal feature elements can be separated. For example, convolution processing can be performed.

### Second Embodiment

In the first embodiment, spatiotemporal feature elements are separated by the graph Fourier transform. This is suitable for time-series data that is difficult for humans to separate feature elements. Meanwhile, feature elements can be easily separated depending on the type of time-series data. Therefore, in order to easily apply the present invention to the latter time-series data, a method of separately encapsulating feature elements in time-series data on the spatial axis and on the time axis will be described in the second embodiment.

As in the first embodiment of FIG. 1, the functional block configuration of the information processing device 1 according to the second embodiment includes the input unit 11, the processing unit 12, the output unit 13, and the storage unit 14. The input unit 11, the output unit 13, and the storage unit 14 have functions similar to those described in the first embodiment.

The processing unit 12 has a function of using a plurality of pieces of time-series data to separately generate a plurality of primary capsules each including a feature vector of each piece of the time-series data and a plurality of primary capsules each including a feature vector at each predetermined time interval.

The processing unit 12 has a function of not only generating the two pluralities of primary capsules, but also generating a feature vector by extracting an entire feature included in the plurality of pieces of the time-series data for each partial region and generating primary capsules each including the feature vector at the each predetermined time interval by using the plurality of pieces of the time-series data.

The processing unit 12 has a function of performing attention routing on each of the three pluralities of primary capsules to generate three digital capsules and inferring a task on the basis of a size of feature vectors included in the three digital capsules.

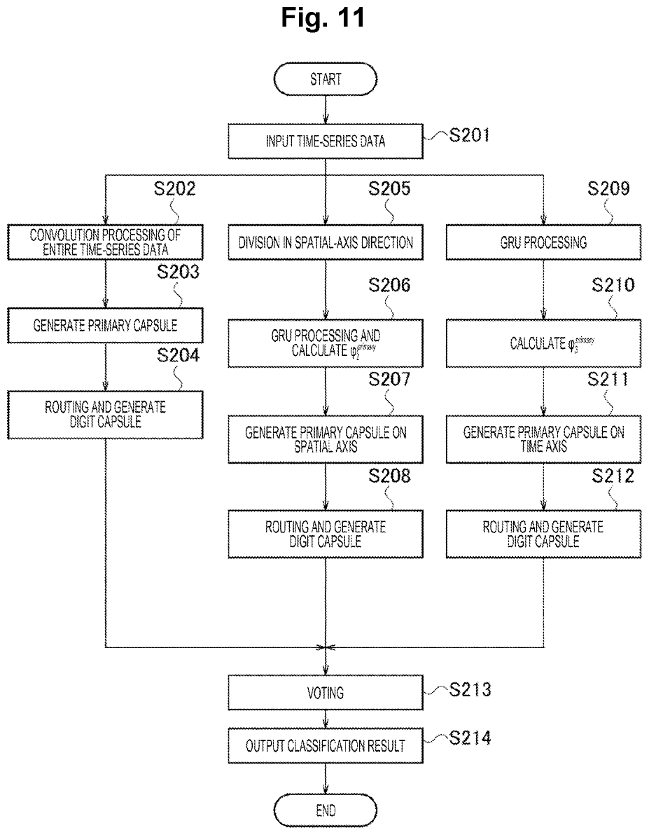

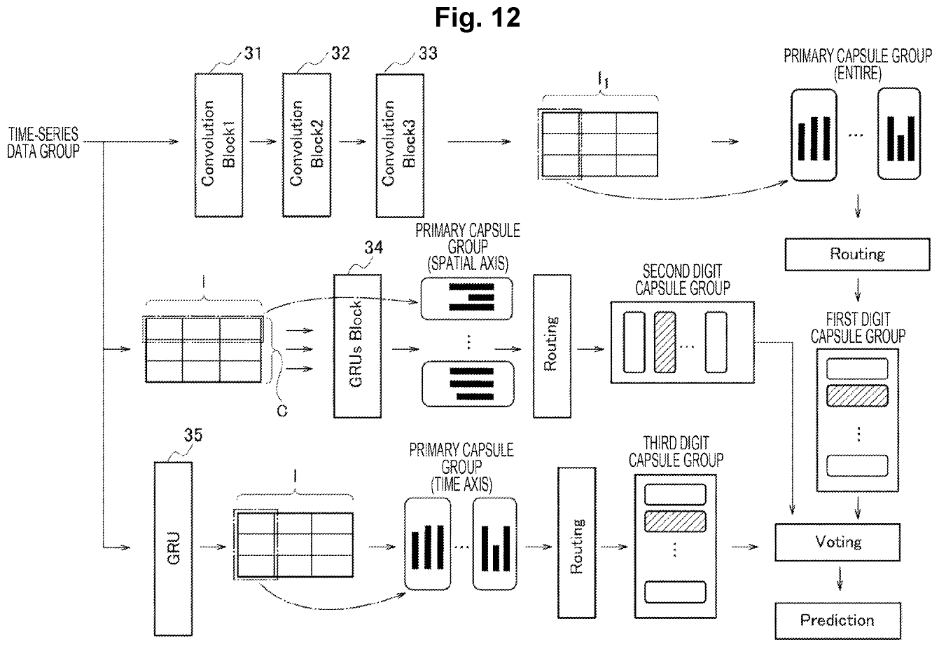

FIG. 11 shows a processing flow of the information processing device 1 according to the second embodiment. FIG. 12 illustrates a processing image of the information processing device 1 according to the second embodiment.

### Step S201;

The input unit 11 inputs a group X {x₁, x₂, . . . , x_{c}} (xᵢ ∈R¹) of c pieces of time-series data. Here, c denotes the total number of pieces of time-series data, and c is also referred to as a channel. R denotes a real number space. 1 denotes a time length of time-series data xᵢ. l also denotes the total number of timestamps (measurement times). The time-series data is, for example, position data of coordinates (x, y, z) of a hand, an elbow, or the like that changes with the lapse of time. The time-series data used in the second embodiment is preferably time-series data other than “data sensitive to the spectral space”.

### Step S202;

Steps S202 to S204 are first branch processing of acquiring an entire feature of the time-series data group X. In the present embodiment, convolution processing is performed to acquire the entire feature. Hereinafter, the processing will be described.

First, the processing unit 12 inputs the group X of c pieces of the time-series data to a first convolutional layer 31 and inputs the output from the first convolutional layer to a second convolutional layer 32.

The first convolutional layer 31 performs convolution processing on the group X of c pieces of the time-series data by using a filter having a kernel size k₁ and the number of target channels c₁. Therefore, a time-series data group X ∈R^{c×l} is transformed into a time-series data group x₁ ∈R^{c1×(1-k1+1)}.

The second convolutional layer 32 performs convolution processing on the time-series data group x₁ ∈R^{c1×(1-k1+1)} by using a filter having a kernel size k₂ and the number of target channels c₂. Therefore, the time-series data group x₁ ∈R^{c1×(1-k1+1)} is transformed into a time-series data group x₂ ∈R^{c2×(1-k1-k2+2)}.

The first convolutional layer 31 and the second convolutional layer 32 perform, for example, various types of processing such as 1D batch normalization processing, application of a rectified linear unit (ReLU), dropout processing at a rate of 0.3, and application of a squeeze and excitation (SE) block.

Thereafter, the processing unit 12 inputs the output from the second convolutional layer 32 to a third convolutional layer 33. The third convolutional layer 33 performs convolution processing on the time-series data group x₂ ∈R^{c2×(1-k1-k2+2)} by using a filter having a kernel size k₃ and the number of target channels c₃. Therefore, the time-series data group x₂ ∈R^{c1×(1-k1-k2+2)} is transformed into a time-series data group x₃ ∈R^{c3×11} (l₁=l−k₁−k₂−k₃+3). Application of the SE block is not performed in the third convolutional layer.

### Step S203;

Next, as shown in Equation (11), the processing unit 12 calculates a learnable matrix W₁ E R^{c3×11} for the time-series data group x₃ to calculate a first primary capsule group Ω₁^{primary}{u₁, u₂, . . . , u₁₁} having a plurality of primary capsules of feature vectors u₁₁ for each timestamp. Thereafter, the processing unit 12 transforms Ω₁^{primary} into Ω₁^{primary} ∈R^{1×c3×11}.

$$\begin{matrix}[ Math . 11 ] & \\ {Ω}_{1}^{primary} = {W}_{1} ∘ {X}_{3} & ( 11 )\end{matrix}$$

### Step S204;

Next, as shown in Equation (12), the processing unit 12 calculates ϕ₁^{digit} ∈R^{cls×c3×11} by calculating routing attention A₁ ∈R^{cls×1×11} for the first primary capsule group Ω₁^{primary}. Here, cls denotes the total number of classification classes.

$$\begin{matrix}[ Math . 12 ] & \\ {ϕ}_{1}^{digit} = {A}_{1} ∘ {Ω}_{1}^{primary} & ( 12 )\end{matrix}$$

Thereafter, the processing unit 12 calculates a first digit capsule group Ω₁^{digit} ∈R^{cls×c3} by summing the last dimension of Ø1digit.

### Steps S205 to S208 (Outline);

After step S201, steps S205 to S208 are performed in parallel with steps S202 to S204. Steps S205 to S208 are second branch processing of dividing the time-series data group X by the spatial axis to acquire a feature of each channel. In the present embodiment, the feature of each channel is acquired by using GRU as in the first embodiment. Hereinafter, the processing will be described.

### Step S205;

First, the processing unit 12 divides the group X E R¹ of c pieces of the time-series data in the spatial-axis direction to acquire a group xₛₑₜ{x₁, x₂, . . . . x_{c}} of c channels.

### Step S206;

Next, the processing unit 12 inputs the time-series data of each channel included in the channel group xₛₑₜ to each GRU 34. Each GRU 34 shares the same parameter, inputs the time-series data of each channel, and outputs c_{gru} feature vectors from one piece of the time-series data via g layers.

Thereafter, the processing unit 12 calculates ϕ₂primary {ϕ′₁, ϕ′₂, . . . , ϕ′_{c}} (ϕ₂^{primary} ∈R^{cgru×c}) by using a hidden state ϕ′∈R^{cgru} of each channel output from each GRU 34.

### Step S207;

Next, as shown in Equation (13), the processing unit 12 calculates a learnable matrix W₂ ∈R^{cgru×c} for ϕ₂^{primary} to calculate a second primary capsule group Ω₂^{primary}{w₁, w₂, . . . , w_{c}} having a plurality of primary capsules of the feature vectors w_{c} of each channel. The length of the signal value included in each capsule of the primary capsule group (spatial axis) illustrated in FIG. 12 indicates a feature value in one channel. Thereafter, the processing unit 12 transforms Ω₂^{primary} into Ω₂^{primary} ∈R^{1×cgru×c}.

$$\begin{matrix}[ Math . 13 ] & \\ {Ω}_{2}^{primary} = {W}_{2} ∘ {ϕ}_{2}^{primary} & ( 13 )\end{matrix}$$

### Step S208;

Next, as shown in Equation (14), the processing unit 12 calculates ϕ₂^{digit} ∈R^{cls×cgru×c} by calculating routing attention A₂ ∈R^{cls×1×c} for the second primary capsule group Ω₂^{primary}. Here, cls denotes the total number of classification classes.

$$\begin{matrix}[ Math . 14 ] & \\ {ϕ}_{2}^{digit} = {A}_{2} ∘ {Ω}_{2}^{primary} & ( 14 )\end{matrix}$$

Thereafter, the processing unit 12 calculates a second digit capsule group Ω₂^{digit} ∈R^{cls×cgru} by summing the last dimension of Ø2digit.

### Steps S209 to S212 (Outline);

After step S201, steps S209 to S212 are performed in parallel with steps S202 to S204. Steps S209 to S212 are third branch processing of dividing the time-series data group X by the time axis to acquire a feature of each timestamp. In the present embodiment, the feature of each timestamp is acquired by using GRU as in the first embodiment. Hereinafter, the processing will be described.

### Step S209;

First, the processing unit 12 inputs a group X ∈R¹ of c pieces of the time-series data to a GRU 35. The GRU 35 inputs the group X of c pieces of the time-series data and then outputs c_{gru} feature vectors via the g layers.

### Step S210;

Next, the processing unit 12 calculates ϕ₃^{primary}{ω₁, ω₂, . . . , ω₁} (ϕ₃^{primary} ∈R^{cgru×l}) by using a hidden state ω E R^{cgru} of each timestamp output from the GRU 35.

### Step S211;

Next, as shown in Equation (15), the processing unit 12 calculates a learnable matrix W₃ ∈R^{cgru×l} for ϕ₃^{primary} to calculate a third primary capsule group Ω₃^{primary}{V₁, V₂, . . . , V₁} having a plurality of primary capsules of the feature vectors V₁ of each timestamp. The length of the signal value included in each capsule of the primary capsule group (time axis) illustrated in FIG. 12 indicates a feature value in one timestamp. Thereafter, the processing unit 12 transforms Ω₃^{primary} into Ω₃^{primary} ∈R^{1×cgru×l}.

$$\begin{matrix}[ Math . 15 ] & \\ {Ω}_{3}^{primary} = {W}_{3} ∘ {ϕ}_{3}^{primary} & ( 15 )\end{matrix}$$

### Step S212;

Next, as shown in Equation (16), the processing unit 12 calculates Ω₂^{digit} ∈R^{cls×cgru×l} by calculating routing attention A₃ ∈R^{cls×1×1} for the third primary capsule group Ω³_{primary}. Here, cls denotes the total number of classification classes.

$$\begin{matrix}[ Math . 16 ] & \\ {ϕ}_{3}^{digit} = {A}_{3} ∘ {Ω}_{3}^{primary} & ( 16 )\end{matrix}$$

Thereafter, the processing unit 12 calculates a third digit capsule group Ω₃^{digit} ∈R^{cls×cgru} by summing the last dimension of Ø3digit.

### Step S213;

Next, the processing unit 12 performs the batch normalization processing and application of the rectified linear unit to each of the first to third digit capsule groups Ωₖ^{digit} (k ∈{1, 2, 3}) and then calculates a norm Vₖ{vote₁^{k}, . . . , vote_{cls}^{k}} which is a voting content of each classification class cls included in each of the digit capsule groups. The norm voteⱼ^{k} is an index indicating reliability of the j-th classification class included in the k-th digital capsule group.

Thereafter, as shown in Equation (17), the processing unit 12 multiplies the norm Vₖ (k ∈{1, 2, 3}) regarding the first to third digit capsule groups by a weight set (a₁, a₂, a₃) for the learnable attention to obtain a sum thereof, thereby calculating a final voting result.

$$\begin{matrix}[ Math . 17 ] & \\ {\sum }_{k = 1}^{3} {a}_{k} {V}_{k} & ( 17 )\end{matrix}$$

That is, a correct answer of each digit capsule group can be found depending on the length of each feature vector included in the digit capsule group. However, the correct answer may be different among the three digit capsule groups, and thus the correct answer is selected by voting on the basis of the weight in step S213. A voting method is, for example, performing weighting with three scalars as described above. A weight considered to be correct is set to be large, and a weight considered to be incorrect is set to be small. The weight may be a weight set by a human or a learned weight.

### Step S214;

Finally, the output unit 13 outputs the voting result as an inference result.

Summarizing the above, in the second embodiment, a primary capsule group that is not separated by the spatial axis or the time axis, a primary capsule group that is separated by the spatial axis, and a primary capsule group that is separated by the time axis are generated for time-series data other than “time-series data sensitive to the spectral space”, then a routing operation is applied to each of the primary capsule groups, and three generated digit capsules are integrated by a learnable voting mechanism. This makes it possible to improve the classification accuracy and also to improve learning process interpretability by branch analysis or the like.

According to the second embodiment, the information processing device 1 includes: the input unit 11 that inputs a plurality of pieces of time-series data measured by a respective plurality of sensors at different positions; and the processing unit 12 that uses the plurality of pieces of the time-series data to separately generate a plurality of primary capsules each including a feature vector of each piece of the time-series data and a plurality of primary capsules each including a feature vector at each predetermined time interval. This makes it possible to apply the present invention also to multidimensional time-series data having feature elements on the time axis and to completely separate the feature elements from each other. As a result, it is possible to provide a technique capable of improving classification accuracy of each feature element included in multidimensional time-series data having feature elements in a spacetime.

### [Others]

The present invention is not limited to the above embodiments. The present invention may be modified in various manners within the gist of the present invention. The first embodiment and the second embodiment may be combined.

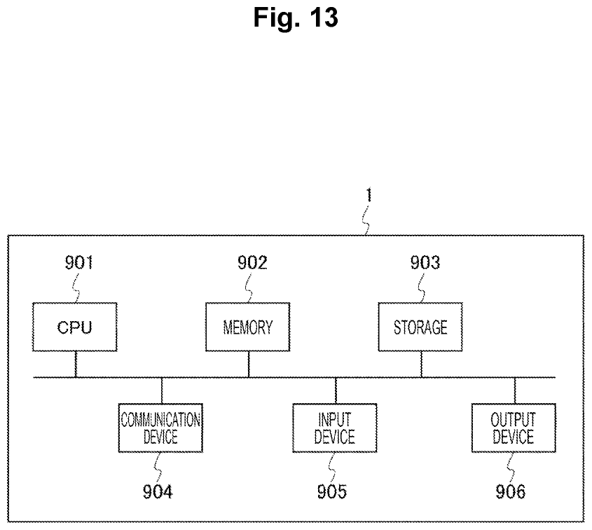

The information processing devices 1 according to the first embodiment and second embodiment described above can be achieved by using, for example, a general-purpose computer system including a CPU 901, a memory 902, a storage 903, a communication device 904, an input device 905, and an output device 906 as shown in FIG. 13. The memory 902 and the storage 903 are storage devices. In the computer system, each function of the information processing device 1 is implemented by the CPU 901 executing a predetermined program loaded on the memory 902.

The information processing device 1 may be implemented by one computer. The information processing device 1 may be implemented by a plurality of computers. The information processing device 1 may be a virtual machine that is implemented in a computer. The program for the information processing device 1 can be stored in a computer-readable recording medium such as an HDD, an SSD, a USB memory, a CD, or a DVD. The program for the information processing device 1 can also be distributed via a communication network.

### REFERENCE SIGNS LIST

1 Information processing device
11 Input unit
12 Processing unit
13 Output unit
14 Storage unit

1. An information processing device comprising:
an input unit configured to input a plurality of pieces of time-series data measured by a respective plurality of sensors at different positions; and
a processing unit, comprising one or more processors, configured to divide the plurality of pieces of the time-series data into a plurality of pieces of partial time-series data at predetermined time intervals, generate a plurality of primary capsules each including a feature vector of each of the plurality of pieces of the partial time-series data regarding the plurality of pieces of the time-series data, perform graph modeling to generate a weighting matrix in which a connection relationship between the plurality of primary capsules is indicated by a weight corresponding to a distance between the plurality of sensors and the predetermined time interval, and perform graph Fourier transform on the feature vector of each of the plurality of primary capsules based on the weighting matrix.

2. The information processing device according to claim 1, wherein the processing unit is configured to:
generate a plurality of capsules in a spectral domain by classifying a plurality of signal values included in a respective plurality of bases obtained by the graph Fourier transform according to signal values at the same position in the bases and calculate attention of a classification class on the basis of a magnitude of the signal values included in the plurality of capsules.

3. An information processing device comprising:
an input unit configured to input a plurality of pieces of time-series data measured by a respective plurality of sensors at different positions; and
a processing unit, comprising one or more processors, configured to use the plurality of pieces of the time-series data to separately generate a plurality of primary capsules each including a feature vector of each piece of the time-series data and a plurality of primary capsules each including a feature vector at each predetermined time interval.

4. The information processing device according to claim 3, wherein the processing unit is configured to:
not only generate the two pluralities of primary capsules, but also generate a feature vector by extracting an entire feature included in the plurality of pieces of the time-series data for each partial region and generate primary capsules each including the feature vector at the each predetermined time interval by using the plurality of pieces of the time-series data.

5. The information processing device according to claim 4, wherein the processing unit is configured to:
perform attention routing on each of the three pluralities of primary capsules to generate three digital capsules and infer a task on the basis of a size of feature vectors included in the three digital capsules.

6. An information processing method performed in an information processing device, the information processing method comprising:
inputting a plurality of pieces of time-series data measured by a respective plurality of sensors at different positions; and
dividing the plurality of pieces of the time-series data into a plurality of pieces of partial time-series data at predetermined time intervals, generating a plurality of primary capsules each including a feature vector of each of the plurality of pieces of the partial time-series data regarding the plurality of pieces of the time-series data, performing graph modeling to generate a weighting matrix in which a connection relationship between the plurality of primary capsules is indicated by a weight corresponding to a distance between the plurality of sensors and the predetermined time interval, and performing graph Fourier transform on the feature vector of each of the plurality of primary capsules based on the weighting matrix.

7-8. (canceled)
